(19) United States
(12) Patent Application Publication
(10) Pub. No.: US 2021/0049473 A1
(43) Pub. Date: Feb. 18, 2021

(54) Systems and Methods for Robust Federated Training of Neural Networks

(71) Applicant: The Board of Trustees of the Leland Stanford Junior University, Stanford, CA (US)

(72) Inventors: Niranjan Balachandar, Plano, TX (US); Daniel L. Rubin, Stanford, CA (US); Liangqiong Qu, Stanford, CA (US)

(73) Assignee: The Board of Trustees of the Leland Stanford Junior University, Stanford, CA (US)

(21) Appl. No.: 16/993,872

(22) Filed: Aug. 14, 2020

Related U.S. Application Data
(60) Provisional application No. 62/886,871, filed on Aug. 14, 2019.

(51) Int. Cl. G06N 3/08; G06N 5/04; G06K 9/62

(52) U.S. Cl. CPC G06N 3/084; G06K 9/6256; G06K 9/6227; G06N 5/046

(57) ABSTRACT

Embodiments of the invention are generally directed to methods and systems for robust federated training of neural networks capable of overcoming sample size and/or label distribution heterogeneity. In various embodiments, a neural network is trained by performing a first number of training iterations using a first set of training data and performing a second number of training iterations using a second set of training data, where training methodology includes a function to compensate for at least one form of heterogeneity. Certain embodiments incorporate image generation networks to produce synthetic images used to train a neural network.

### CROSS REFERENCE TO RELATED APPLICATIONS

This application claims priority to U.S. Provisional Application Ser. No. 62/886,871, entitled “Systems and Methods for Robust Federated Training of Neural Networks” to Balachandar et al., filed Aug. 14, 2019, which is incorporated herein by reference in its entirety.

### STATEMENT REGARDING FEDERALLY SPONSORED RESEARCH OR DEVELOPMENT

This invention was made with Government support under contract CA190214 awarded by the National Institutes of Health. The government has certain rights in the invention.

### FIELD OF THE INVENTION

The present invention is directed to machine learning, including methods for federated training of models where the training data contains sensitive or private information preventing or limiting the ability to share the data across institutions.

### BACKGROUND OF THE INVENTION

In recent years, deep learning methods, and in particular deep convolutional neural networks (CNNs), have brought about rapid progress in image classification. There is now tremendous potential of using these powerful methods to create many decision tools for imaging that span many diseases and imaging modalities, such as diabetic retinopathy in retinal fundus images, lung nodules in chest CT, and brain tumors in MRI. A major unsolved challenge, however, is obtaining image data from many different hospitals to make the training data broadly representative so that AI models that will generalize to other institutions. Efforts to create large centralized collections of image data are hindered by regulatory barriers to patient data sharing and secure storage, costs of image de-identification, and patient privacy concerns. These barriers greatly limit the progress of AI development and evaluation by industry, requiring complex agreements with hospitals to share their data. Although there are already a few current efforts to produce tools for federated learning, these systems focus on non-medical applications. Due to unique and challenging aspects of medical data and of hospital computing capacities, specialized approaches are necessary for distributed deep learning for medical applications.

### SUMMARY OF THE INVENTION

Systems and methods for robust federated learning of neural networks in accordance with embodiments of the invention are disclosed.

In one embodiment, a method for robust federated training of neural networks includes performing a first number of training iterations with a neural network using a first set of training data and performing a second number of training iterations with the neural network using a second set of training data, where the training methodology includes a function to compensate for at least one of sample size variability and label distribution variability between the first set of training data and the second set of training data.

In a further embodiment, the first set of training data and the second set of training data set are medical image data.

In another embodiment, the first set of training data set and the second training data set are located at different institutions.

In a still further embodiment, the neural network is trained in accordance with a training strategy selected from the group consisting of: asynchronous gradient descent, split learning, and cyclical weight transfer.

In still another embodiment, the first number of iterations is proportional to the sample size in the first set of training data and the second number of iterations is proportional to the sample size in the second set of training data.

In a yet further embodiment, a learning rate of the neural network is proportional to sample size in the first set of training data and the second set of training data, such that the learning rate is smaller where a set of training data is small and the learning rate is larger when a set of training data is large.

In yet another embodiment, local training samples are weighted by label during minibatch sampling so that the data from each label is equally likely to get selected.

In a further embodiment again, the function to compensate is a cyclically weighted loss function giving smaller weight to a loss contribution from labels over-represented in a training set and greater weight to a loss contribution from labels under-represented in a training set.

In another embodiment again, a method for robust federated training of neural networks includes training an image generation network to produce synthetic images using a first set of training data, training the image generation network to produce synthetic images using a second set of training data, and training a neural network based on the synthetic images produced by the image generation network.

In a further additional embodiment, the synthetic images do not contain sensitive or private information for a patient or study participant.

In another additional embodiment, the method further includes training a universal classifier model based on the first set of training data, the second set of training data, and the synthetic images.

In a still yet further embodiment, the first set of training data set and the second training data set are located at different institutions.

In still yet another embodiment, the first set of training data and the second set of training data set are medical image data.

In a still further embodiment again, the neural network is trained in accordance with a training strategy selected from the group consisting of: asynchronous gradient descent, split learning, and cyclical weight transfer.

In still another embodiment again, a method for robust federated training of neural networks includes creating a first intermediate feature map from a first set of training data, wherein the first intermediate feature map is accomplished by propagating the first set of training data through a first part of a neural network, creating a second intermediate feature map from a second set of training data, wherein the second intermediate feature map is accomplished by propagating the second set of training data through a first part of a neural network, transferring the first intermediate feature map and the second intermediate feature map to a central server, wherein the central server concatenates the first intermediate feature map and the second intermediate feature map, and propagating the concatenated feature maps though a second part of the neural network.

In a still further additional embodiment, the method further includes generating final weights from the second part of the neural network.

In still another additional embodiment, the first set of training data set and the second training data set are located at different institutions.

In a yet further embodiment again, the method further includes back propagating the final weights through the layers to each institution.

### BRIEF DESCRIPTION OF THE DRAWINGS

These and other features and advantages of the present invention will be better understood by reference to the following detailed description when considered in conjunction with the accompanying drawings where:

FIG. 1 illustrates a flow chart showing a method to train a neural network in accordance with various embodiments of the invention.

FIG. 2 illustrates a schematic of cyclical weight transfer to train a neural network in accordance with various embodiments of the invention.

FIGS. 3A-3B illustrate schematics of generative methods of training a neural using cyclical weight transfer in accordance with various embodiments of the invention.

FIG. 4 illustrates a schematic of a generative method of training a neural network in accordance with various embodiments of the invention.

FIG. 5 illustrates a schematic of a split averages method for training a neural network in accordance with various embodiments of the invention.

FIG. 6 illustrates a flow chart showing a method to treat an individual based using an artificial intelligence and/or machine learning model.

FIGS. 7A-7B illustrate line graphs of results showing the accuracy of federated training methods in accordance with various embodiments of the invention.

FIGS. 8A-8B illustrate line graphs of results showing the accuracy of federated training methods in accordance with various embodiments of the invention.

FIG. 9A illustrates a bar graph of accuracy of federated training methods in accordance with various embodiments of the invention.

FIG. 9B illustrates a bar graph of performance of federated training methods in accordance with various embodiments of the invention.

FIG. 10A illustrates a bar graph of accuracy of federated training methods in accordance with various embodiments of the invention.

FIG. 10B illustrates a bar graph of performance of federated training methods in accordance with various embodiments of the invention.

### DETAILED DESCRIPTION

Turning now to the diagrams and figures, embodiments of the invention are generally directed to federated learning systems for machine learning (ML) and/or artificial intelligence (AI) based medical diagnostics. Many embodiments use federated (distributed) learning. To obviate privacy, storage, and regulatory concerns, federated learning of many embodiments train AI models on local patient data, and numeric model parameters (weights) are transferred between institutions instead of patient data. While many embodiments described herein discuss usage for medical imaging, various embodiments are extendible to other types of data susceptible to privacy laws and regulations, including clinical notes.

Many embodiments use a Cyclical Weight Transfer (CWT) methodology. CWT works well in the setting of varied hardware capability across sites. However, there are other unique challenges to distributed learning with medical data not yet addressed. Specifically, inter-institutional variations in the amount of data across sites (size heterogeneity), distribution of labels (label distribution heterogeneity), and image resolution require research to define the optimal approach to handling these heterogeneities in data in the distributed learning setting, and different optimizations are likely needed for image classification, regression, and segmentation. While many embodiments use CWT, any number of different federated training methodologies can be utilized by embodiments, including, but not limited to, asynchronous gradient descent, split learning, and/or any other methodology as appropriate for specific applications of certain embodiments. While CWT provides a very strong methodology for federated training, certain embodiments implement additional, federated methodologies to train models using additional methodologies that overcome variability and/or heterogeneity between institutions.

Additionally, many embodiments show an improvement over traditional CWT methodologies in simulated, distributed tasks, including (but not limited to) abnormality detection on retinal fundus imaging, chest X-rays, and X-rays of limbs (e.g., hands). As such, certain embodiments are capable of diagnosing diseases of the eye (e.g., diabetic retinopathy) and thoracic diseases, including atelectasis, cardiomegaly, effusion, infiltration, mass, nodule, pneumonia, pneumothorax, consolidation, edema, emphysema, fibrosis, pleural thickening, and/or hernia. It is further understood that any number of diseases can be diagnosed using systems and methods described herein without departing from the scope or spirit of the invention.

### Algorithm Training

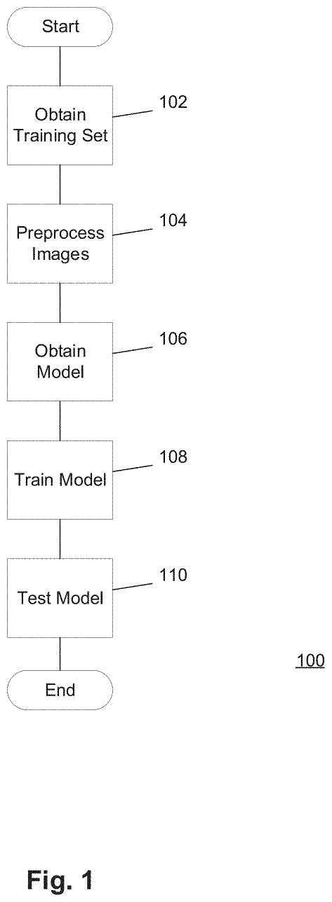

Turning to FIG. 1, method 100 of many embodiments is illustrated. As noted above, many embodiments are based on CWT to perform federated training. As such, many embodiments obtain a training dataset at 102. In many embodiments, the training dataset includes a plurality of individual datasets, where each individual dataset is located at an individual institution, such as a medical clinic, hospital, medical school, and/or any other medical facility as appropriate to the requirements of specific applications of embodiments of the invention. In various embodiments, the training dataset is a collection of images. Many embodiments obtain the images from medical imaging devices, including photography, fundus imaging, X-ray, ultrasound, PET, CT, OCT, and/or any other imaging system or device.

At 104, many embodiments preprocess images in the training dataset. In various embodiments, preprocessing involves identifying images based on qualitative measures (e.g., disease labels) and/or quantitative measures (e.g., severity of disease progression). Certain embodiments base the identification on binary, such as “diseased” or “not diseased.” Additional embodiments adjust size and/or resolution of images for consistency across individual datasets. Further embodiments limit images to a single view and/or image for individual subjects in a set; for example, certain embodiments limit images in a training set to just right eyes (e.g., for funduscopic imaging) or just posterior-anterior view (e.g., for X-ray imaging) to prevent confounding from multiple views or images from any one individual. Certain embodiments perform color correction in images, such as by subtracting a local average color. Some embodiments perform intensity correction by subtracting each image by the pixel-wise mean intensity across the images to zero-center the data and dividing each image by the pixel-wise standard deviation intensity across the images to normalize the scale of the data. In certain embodiments, one or more subsets of preprocessed images are separated from the training set to be used for testing and/or validating a trained model.

Many embodiments obtain a machine learning model at 106. Certain embodiments select an appropriate model for a particular application. In certain embodiments, the model is a convolutional neural network. Some embodiments use a deep classification model, such as GoogLeNet. In certain embodiments, a batch normalization layer is included after each convolutional layer and a dropout layer before a final readout layer. Various embodiments use a probability of 0.5 in the dropout layer. Various embodiments use minibatch sampling with an appropriate batch size. In some of these embodiments, the batch size is 32. Many embodiments use an optimization algorithm for model weight optimization. Certain embodiments use the Adam optimization algorithm with initial learning rate of 0.001 to 0.0015 for the training dataset. Various embodiments initialize weights with Xavier Initialization. Various embodiments select exponential learning rate decay based on epochs. In some embodiments exponential learning rate decay rate of 0.99 for every 200 iterations (every epoch). Further embodiments use cross entropy loss with an L2 regularization coefficient of 0.0001 as the loss function for a dataset. Additionally, some embodiments terminate model learning early, if an amount of iterations or epochs pass without an improvement in validation loss (e.g., model learning terminates if 4000 iterations and/or 20 epochs pass without an improvement in validation loss). Further embodiments perform real-time data augmentation into the training dataset by introducing rotations (e.g., 0-360° rotations), random shading, and random contrast adjustment to each image in a minibatch at every training iteration. However, parameters described herein may be tuned to alternative values as appropriate to the requirements of specific applications of embodiments of the invention.

At 108, many embodiments train an obtained model. Many embodiments perform federated training of the model to allow training to occur from multiple institutions or locations. Many embodiments use CWT as a baseline, distributed approach, because CWT allows for synchronous, non-parallel training, and therefore CWT is robust to discrepancies in machine configurations across training institutions. However, several embodiments perform federated training using non-CWT methodologies. Exemplary training methodologies are described elsewhere herein.

Many embodiments test the model at 110. Testing the model can be accomplished using a set of images set aside for testing the trained model (e.g., a subset of images from 104).

### Model Training Methodologies

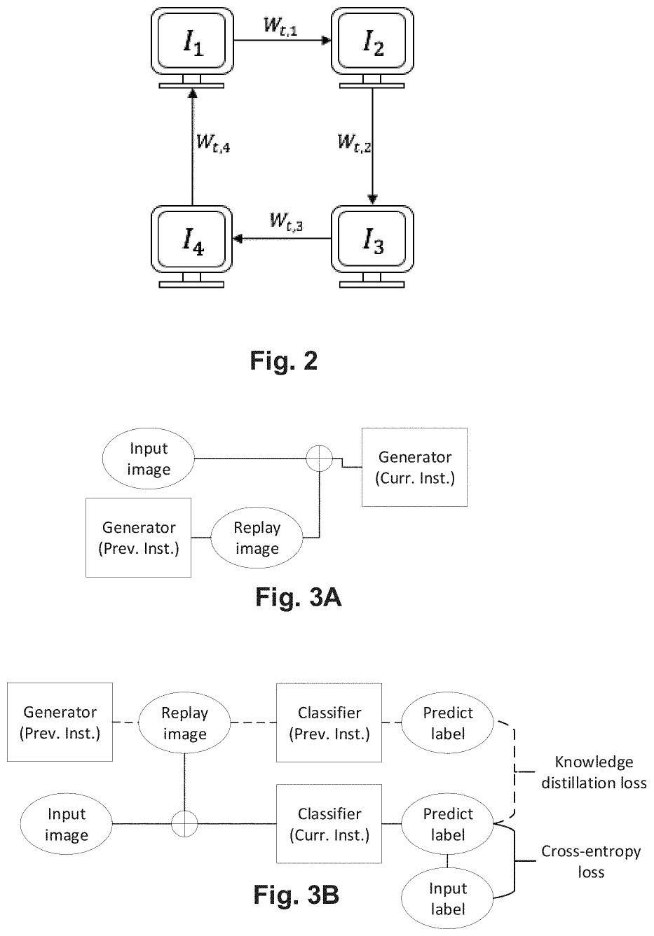

Many embodiments accomplish federated training using CWT. CWT, in accordance with many embodiments, involves starting training at one institution for a certain number of iterations, transferring the updated model weights to a subsequent institution, training the model at the subsequent institution for a certain number of iterations, then transferring the updated weights to the next institution, and so on until model convergence. An exemplary schematic of cyclical weight transfer with four participating institutions in accordance with an embodiment of the invention is included in FIG. 2. In particular, FIG. 2 illustrates an example of CWT with four participating institutions (I₁, I₂, I₃, and I₄), where I₁ is the starting institution, and each arrow represents transfer of model weights W_{t,i} at cycle t for iϵ{1,2,3,4}. FIG. 2 illustrates an exemplary training system involving four institutions. As such, various embodiments implementing CWT trains a model with any number of individual institutions (e.g., 2 or more). Additionally, certain embodiments train a model from a single institution, such as when privacy laws prohibit sharing of information between groups within an institution and/or for simulating training at multiple institutions using data from a single institution.

While CWT is a robust methodology for federated training, a key limitation with the existing implementation of CWT is that it is not optimized to handle variability or heterogeneity in sample sizes, label distributions, and resolutions in the training data across institutions. In fact, CWT performance decreases when these variabilities are introduced. As such, many embodiments include manipulations or modifications on CWT to compensate for and/or improve CWT when sample sizes or label distributions differ between locations or institutions. Such modifications include proportional local training iterations (PLTI) and/or cyclical learning rate (CLR) to compensate for sample size variability and locally weighted minibatch sampling (LWMS) and/or cyclically weighted loss (CWS) to compensate for label distribution variability. Various embodiments use one of the modified CWT strategies, while certain embodiments use multiple modifications, such that certain embodiments use both PLTI and CWL to simultaneously compensate for sample size variability and label distribution variability.

CWT involves training at each institution for a fixed number of iterations before transferring updated weights to the next institution. This could lead to diminished performance when sample sizes vary across institutional training splits because the images from institutions with smaller training sample sizes would be disproportionately selected more frequently in minibatch selections over the course of distributed training, and the images from institutions with larger training sample sizes would be disproportionately selected less frequently in minibatch selections over the course of distributed training. Various embodiments implement proportional local training iterations (PLTI) and/or cyclical learning rate (CLR) strategies to compensate for variability in sample sizes across institutional training splits.

In embodiments implementing PLTI, the model is trained at each institution for a number of iterations proportional to the training sample size at the institution, instead of a fixed number of training iterations at each institution. For example, if there are i participating institutions 1, . . . , i, with training sample sizes of ₙ₁, . . . , nᵢ respectively, then the number of training iterations at institution k will be:

$$f \cdot \frac{{n}_{k}}{{\sum }_{j = 1}^{i} {n}_{j}}$$

Where f is some scaling factor. With this modification, each training example across institutions is expected to appear the same number of times on average of the course of training. If:

$$f = \frac{{\sum }_{j = 1}^{i} {n}_{j}}{B}$$

Where B is the batch size, then a single full cycle of cyclical weight transfer represents an epoch over the full training data.

Embodiments implementing CLR equalize the contribution of each images across the entire training set by adjusting the learning rate at each training institution. Having a smaller learning rate at institutions with smaller sample sizes and a larger learning rate at institutions with larger sample sizes will prevent disproportionate impact of the images at institutions with small or large sample sizes on the model weights. Specifically, if there are i participating institutions 1, . . . , i, with training sample sizes of n₁, . . . , nᵢ respectively, then the learning rate αk while training at institution k is:

$${a}_{k} = \frac{{n}_{k} i α}{{\sum }_{j = 1}^{i} {n}_{j}}$$

where α is the global learning rate.

Another issue affecting model performance is label distribution variability, where different institutions possess differences in label distribution. Various embodiments implement locally weighted minibatch sampling (LWMS) and/or cyclically weighted loss (CWS) to mitigate performance losses arising from variability in label distribution across institutional training splits.

In embodiments implementing LWMS, local training samples are weighted by label during minibatch sampling so that the data from each label is equally likely to get selected. For example, suppose there are L possible labels, and for each label mϵ{1, . . . , L} there are n_{k,m} samples with label m at institution k. Then each training sample at institution k with label m is given a weight of

$$\frac{1}{l \cdot {n}_{k , m}}$$

for random minibatch sampling at each local training iteration. With such a sampling approach, these embodiments ensure that the minibatches during training have a balanced label distribution at each institution even if the overall label distribution at the training institution is imbalanced.

In embodiments implementing CWS, the standard cross entropy loss function for sample x is CE(x)=−Σⱼ₌₁^{L}y_{x,j} log(p_{x,j}) where i is the number of participating institutions, L is the number of labels, yₓϵ [symbol] ^{L} is a one-hot ground truth vector for sample x with 1 corresponding the entry of the true label of x and 0 for all other entries, and p_{x,j} is the model prediction probability that sample x has label j. Various embodiments introduce a cyclically weighted loss function that gives smaller weight to the loss contribution from labels over-represented at an institution, and vice versa for under-represented labels. The modified cyclically weighted cross entropy loss function at institution k becomes:

$$C {E}_{k} ( x ) = - \frac{{\sum }_{j = 1}^{L} {y}_{x , j} log ( {p}_{x , j} )}{L \cdot {n}_{k , j}}$$

Where n_{k,j} is the proportion of samples at institution k with label j.

In addition to PLTI, CLS, LWMS, and CWS, various embodiments incorporate generative models for model training. Turning to FIGS. 3A-3B, an exemplary training methodology incorporating generative learning into CWT. In particular, this embodiment first trains a universal image generation network on local institutions to produce synthetic images that closely resemble patient images. The trained generator is shared between institutions, and then starts a standard CWT training based on the local data and the synthetic images from the shared image generation network. As such, the image generation network is also trained in a serial way, where image generation network training is finished at one institution, then transferred to a subsequent institution for training. Training at subsequent institutions involve training an updated image generation network based on the replay synthetic images and images from the subsequent institution. In certain embodiments, the image generation network is an auto encoder and/or generative adversarial network. Additionally, various embodiments train a universal classifier model based on local datasets and generated synthetic images from each location/institution. As synthetic images are generated as part of the image generation network, these synthetic images do not necessarily contain sensitive or private information for patients or study participants. After production of synthetic images, a neural network can be trained using the synthetic images.

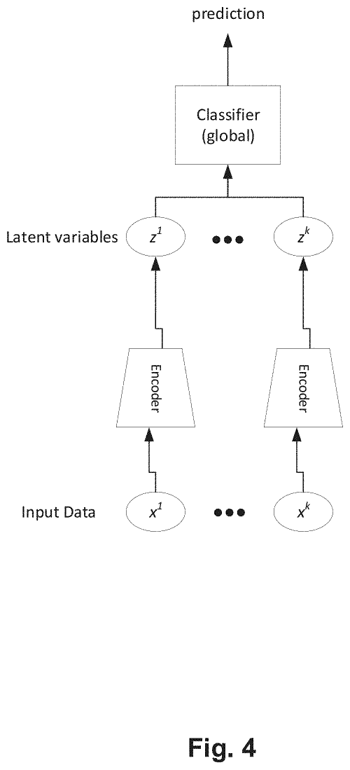

Turning to FIG. 4, another example of federated and generative training is illustrated in accordance with various embodiments. Specifically, FIG. 4 illustrates how some embodiments possess a unique auto-encoder network that is applied to extract latent variables from local institutions (e.g., each institution possesses an auto-encoder). Latent variables generated from each of the auto-encoders is transferred to a central server, which are then used to train a unique classifier, or model global model. In such embodiments, the generative training method uses only one communication between each local institution and a central server, increasing time efficiency.

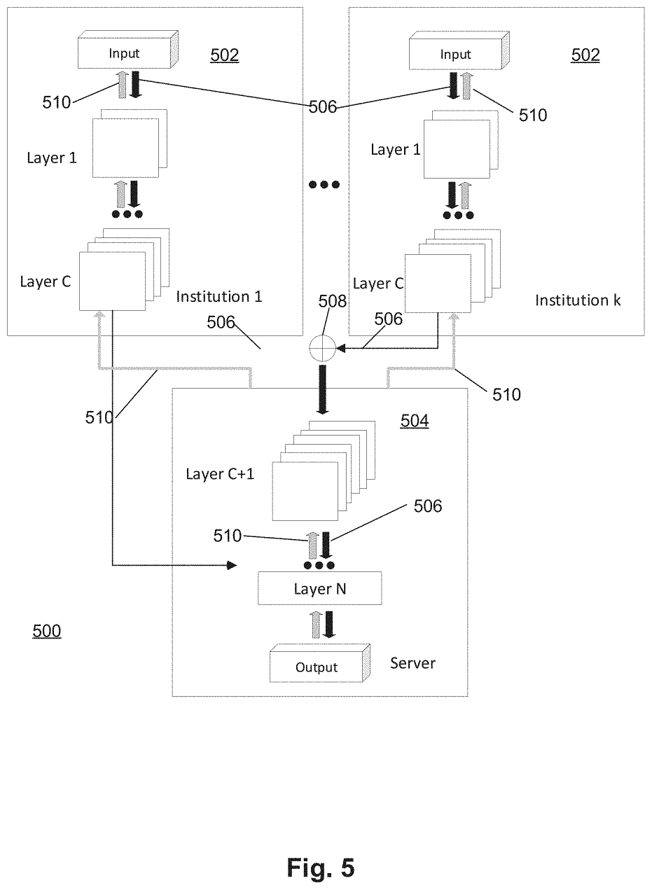

FIG. 5 illustrates an additional federated learning methodology 500 in accordance with certain embodiments, referred to as a “split average” or “SplitAVG” method. In a split average method, a network architecture (e.g., neural network) is split into two parts 502, 504, where each institution forward propagates 506 input data through a first part 502 of the model until a cut layer (Layer C), creating an intermediate feature map. Intermediate feature maps from each institution are obtained and concatenated 508 by a single computing device, such as a central server. The central server then completes forward propagation 506 of the data through a second part 504 of the model to generate final weights. Certain embodiments back propagate 510 final weights obtained in the model to the cut layer (Layer C+1) and through each institution.

### Diagnosing and Treating Diseases

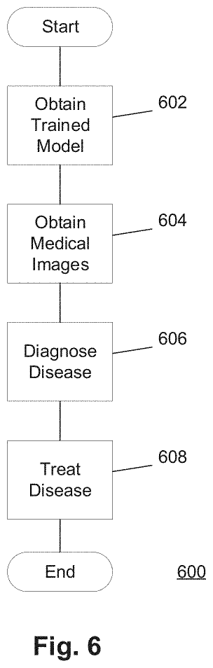

Turning to FIG. 6, certain embodiments are directed to methods 600 to diagnose and/or treat an individual for a disease. At 602, various embodiments train an AI model for diagnosing a disease or obtain an AI model trained to diagnose a disease. Various models are trained by methods disclosed herein, including via method 100 in FIG. 1.

At 604, many embodiments obtain one or more medical images from a patient of the sort used to train the model. For example, if the model is trained via funduscopic imaging, the one or more medical images would be of funduscopic images. Additionally, if the model is trained using chest X-rays, images obtained in 604 would be chest X-rays.

Many embodiments diagnose a disease a disease or disease severity in the patient's medical images at 606, and further embodiments treat the individual for the disease or to mitigate disease severity at 608.

### Improvements in Model Training

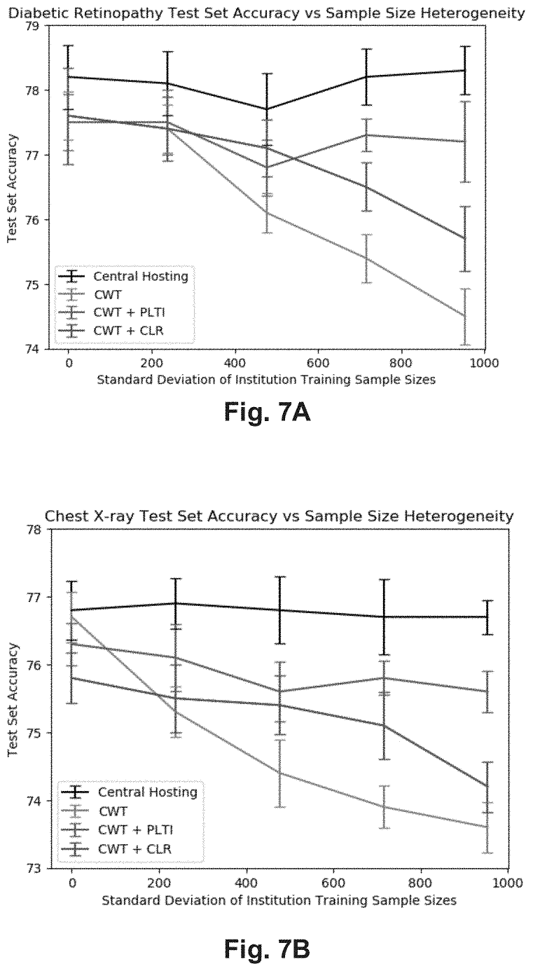

Many embodiments exhibit improved training over traditional CWT training methodologies that, as discussed herein, can have poor performance due to differences in size and disease label distribution. In particular, Table 1 illustrates simulated data sets (Splits 1-5) where a training data set comprising 6400 images split into 4 subsets representing 4 institutions. Each subset in these exemplary, simulated data represent varying numbers of images at each institution but with equal amounts of binary labels (e.g., +/− or diseased/healthy). Table 2 lists accuracy for each of the splits as demonstrated on models trained using diabetic retinopathy funduscopic images (DR) and chest X-rays (CXR). Specifically, Table 2 demonstrates central hosting as a standard where the model is trained locally, while CWT, CWT+PLTI, and CWT+CLR represent federated training methodologies in accordance with some embodiments. Bolded numbers in Table 2 demonstrate significantly better performance with the modifications than traditional CWT. Similarly, FIGS. 7A-7B graphically illustrate results of these exemplary training methodologies, where FIG. 7A illustrates exemplary results from diabetic retinopathy trainings, and FIG. 7B illustrates exemplary results from chest X-ray trainings.

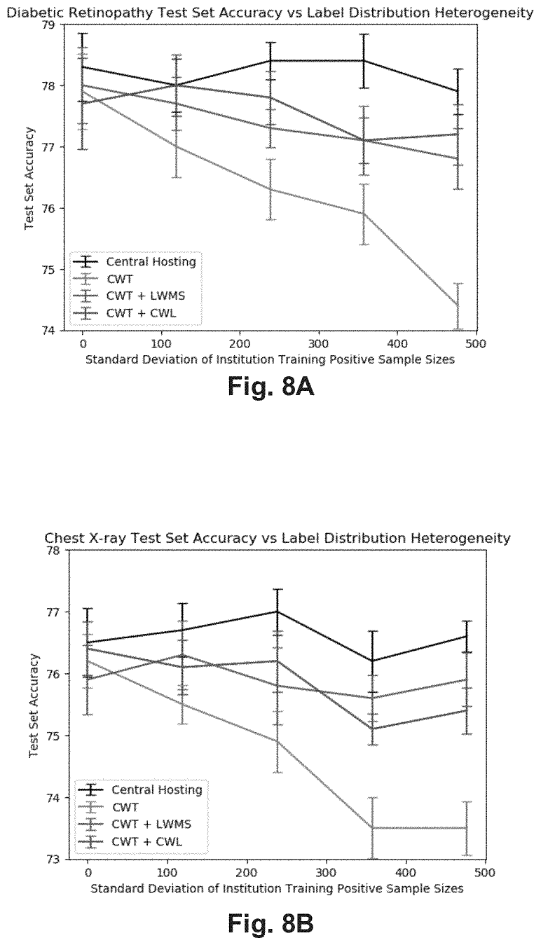

Additionally, many embodiments illustrate improvements for label distribution heterogeneity, as illustrated by exemplary embodiments demonstrated in Tables 3-4 and FIGS. 8A-8B. Specifically, Table 3 illustrates simulated data sets (Splits 6-10) where a training data set comprising 6400 images split into 4 subsets representing 4 institutions. Each subset in these exemplary, simulated data represent varying amounts of binary labels (e.g., +/− or diseased/healthy) but with equal numbers of images at each institution. Table 4 lists accuracy for each of the splits as demonstrated on models trained using diabetic retinopathy funduscopic images (DR) and chest X-rays (CXR). Specifically, Table 4 demonstrates central hosting as a standard where the model is trained locally, while CWT, CWT+LWMS, and CWT+CWL represent federated training methodologies in accordance with some embodiments. Bolded numbers in Table 4 demonstrate significantly better performance with the modifications than traditional CWT. Similarly, FIGS. 8A-8B graphically illustrate results of these exemplary training methodologies, where FIG. 8A illustrates exemplary results from diabetic retinopathy trainings, and FIG. 8B illustrates exemplary results from chest X-ray trainings.

Certain embodiments of CWT with modifications use more than one modification (e.g., PLTI and CWL) to increase accuracy for size heterogeneity and label distribution heterogeneity, such as illustrated in Tables 5-6. In particular Table 5 illustrates simulated data sets (Splits 11-12) where a training data set comprising 6400 images split into 4 subsets representing 4 institutions. Each subset in these exemplary, simulated data represent varying amounts sample size and label distribution: Split 11 shows equal size and label distribution, while Split 12 demonstrates both size and label distribution heterogeneity as indicated in the sample size standard distribution columns. Table 6 lists accuracy for each of the splits as demonstrated on models trained using diabetic retinopathy funduscopic images (DR). Specifically, Table 6 demonstrates central hosting as a standard where the model is trained locally, while CWT, CWT+PLTI, and CWT+CWL, and CWT+PLTI+CWL represent federated training methodologies in accordance with some embodiments. As demonstrated in Table 6, the combination of PLTI and CWL increases accuracy above CWT alone or with only one type of modification.

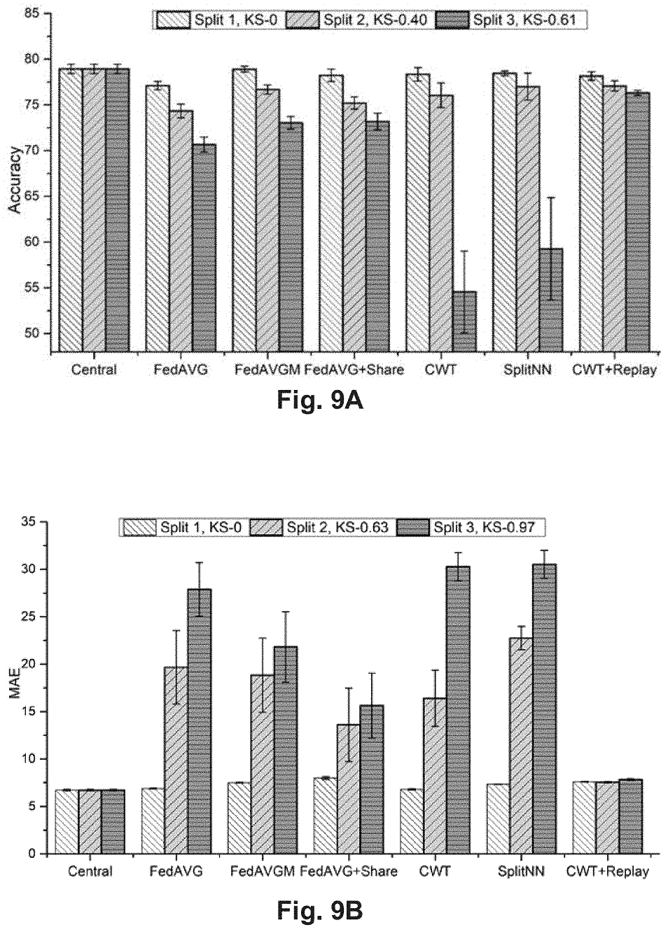

Turning to FIGS. 9A-9B, accuracies of an exemplary generative training methods are illustrated against benchmarking methodologies. Specifically, FIG. 9A illustrates a bar graph illustrating accuracy of various training methodologies, while FIG. 9B a bar graph illustrating performance of various training methodologies as compared to a CWT methodology using generative training (“CWT+Replay;” e.g., the exemplary embodiment illustrated in FIG. 3). Splits 1-3 illustrate varying levels of label distribution skew, as a measured by the Kolmogorov-Smirnov (KS) statistic between every two institutions to measure the degree of label distribution skew. KS=0 means IID data partitions, while KS=1 indicates identically different label distributions across institutions. As illustrated in FIG. 9A, as the heterogeneity increases (e.g., Splits 2-3), accuracy decreases in the federated methodologies (FedAVG, FedAVGM, FedAVG+Share, CWT, SplitNN, CWT+Replay). However, the exemplary embodiment of CWT+Replay maintains a higher accuracy than the other benchmarking methods. The performances of these methodologies are illustrated in FIG. 9B, which illustrates mean absolute error (MAE) loss (lower numbers are better for this statistic), showing improved performance for the exemplary CWT+Replay methodology as compared to other federated methodologies.

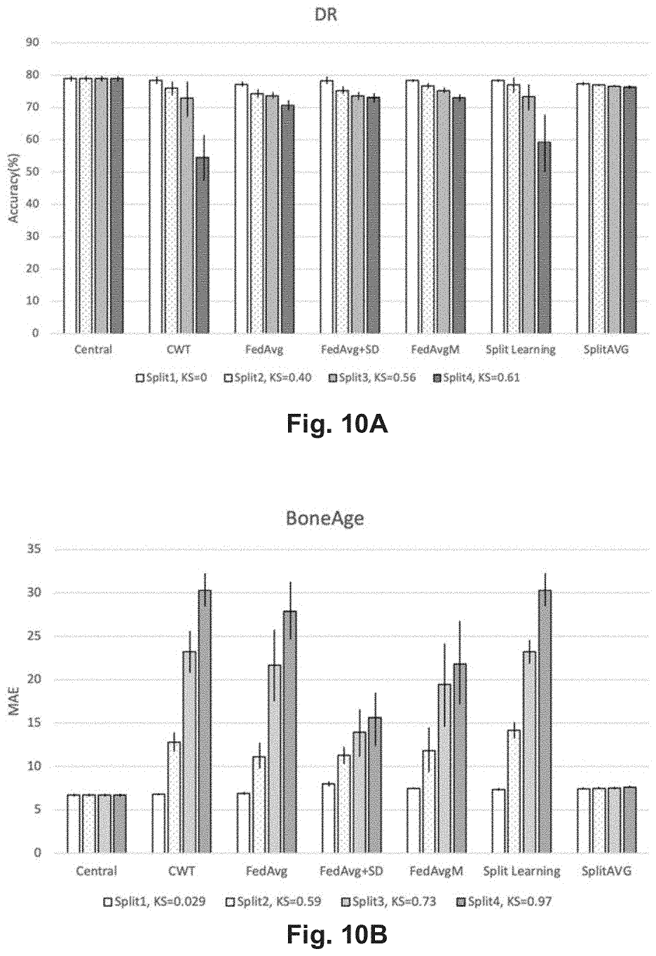

Turning to FIGS. 10A-10B, accuracies of an exemplary SplitAVG training methods are illustrated against benchmarking methodologies. Specifically, FIG. 10A illustrates a bar graph illustrating accuracy of various training methodologies, while FIG. 10B a bar graph illustrating performance of various training methodologies as compared to a SplitAVG methodology e.g., the exemplary embodiment illustrated in FIG. 5). Splits 1-4 illustrate varying levels of label distribution skew, as a measured by the Kolmogorov-Smirnov (KS) statistic. As illustrated in FIG. 10A, as the heterogeneity increases (e.g., Splits 2-4), accuracy decreases in the federated methodologies (CWT, FedAVG, FedAVG+SD, FedAvgM, Split Learning, SplitAVG). However, the exemplary embodiment of SplitAVG maintains a higher accuracy than the other benchmarking methods. The performances of these methodologies are illustrated in FIG. 10B, which illustrates mean absolute error (MAE) loss (lower numbers are better for this statistic), showing improved performance for the exemplary SplitAVG methodology as compared to other federated methodologies.

### DOCTRINE OF EQUIVALENTS

Although specific methods of producing lignin-modifying enzymes are discussed above, many production methods can be used in accordance with many different embodiments of the invention, including, but not limited to, methods that use other plant hosts, other bacterium, and/or any other modification as appropriate to the requirements of specific applications of embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

TABLE 1
Institutional training splits with varying degrees of sample
size standard deviation across the four institutions.
The number of positive and negative samples at each institution
are also indicated (each split is balanced).

| | | | | | Sample Size |
|---|---|---|---|---|---|
| Split | Inst1+/− | Inst2+/− | Inst3+/− | Inst4+/− | Std. Dev. |
| 1 | 800/800 | 800/800 | 800/800 | 800/800 | 0.0 |
| 2 | 960/960 | 853/853 | 747/747 | 640/640 | 238.4 |
| 3 | 1120/1120 | 907/907 | 693/693 | 480/480 | 477.2 |
| 4 | 1280/1280 | 960/960 | 640/640 | 320/320 | 715.5 |
| 5 | 1440/1440 | 1013/1013 | 587/587 | 160/160 | 953.9 |

TABLE 2
Diabetic retinopathy and Chest X-ray mean and standard deviation
test set accuracies across 10 runs for the various sample
size splits with centrally hosted and distributed training.
Bold entries represent optimizations that resulted in significantly
better performance than performance of cyclical weight transfer
without optimizations for the same split.

| | DR Test Accuracy | CXR Test Accuracy |
|---|---|---|
| Model | Mean ± Std. Dev. | Mean ± Std. Dev. |
| Split 1 | | |
| Central Hosting | 78.2 ± 0.8 | 76.8 ± 0.7 |
| CWT | 77.6 ± 0.6 | 76.7 ± 0.6 |
| CWT + PLTI | 77.5 ± 0.7 | 76.3 ± 0.5 |
| CWT + CLR | 77.6 ± 1.2 | 75.8 ± 0.6 |
| Split 2 | | |
| Central Hosting | 78.1 ± 0.8 | 76.9 ± 0.6 |
| CWT | 77.4 ± 0.6 | 75.3 ± 0.6 |
| CWT + PLTI | 77.5 ± 0.8 | 76.1 ± 0.8 |
| CWT + CLR | 77.4 ± 0.8 | 75.5 ± 0.8 |
| Split 3 | | |
| Central Hosting | 77.7 ± 0.9 | 76.8 ± 0.8 |
| CWT | 76.1 ± 0.5 | 74.4 ± 0.8 |
| CWT + PLTI | 76.8 ± 0.7 | 75.6 ± 0.7 |
| CWT + CLR | 77.1 ± 0.7 | 75.4 ± 0.7 |
| Split 4 | | |
| Central Hosting | 78.2 ± 0.7 | 76.7 ± 0.9 |
| CWT | 75.4 ± 0.6 | 73.9 ± 0.5 |
| CWT + PLTI | 77.3 ± 0.4 | 75.8 ± 0.4 |
| CWT + CLR | 76.5 ± 0.6 | 75.1 ± 0.8 |
| Split 5 | | |
| Central Hosting | 78.3 ± 0.6 | 76.7 ± 0.4 |
| CWT | 74.5 ± 0.7 | 73.6 ± 0.6 |
| CWT + PLTI | 77.2 ± 1.0 | 75.6 ± 0.5 |
| CWT + CLR | 75.7 ± 0.8 | 74.2 ± 0.6 |

TABLE 3
Institutional training splits with varying degrees of positive label
sample size standard deviation across the four institutions. The
number of positive and negative samples at each institution are
(each split as equal total sample size across institutions).

| | | | | | Pos. Sample |
|---|---|---|---|---|---|
| Split | Inst1+/− | Inst2+/− | Inst3+/− | Inst4+/− | Size Std. Dev. |
| 6 | 800/800 | 800/800 | 800/800 | 800/800 | 0.0 |
| 7 | 960/640 | 853/747 | 747/853 | 640/960 | 119.2 |
| 8 | 1120/480 | 907/693 | 693/907 | 480/1120 | 238.6 |
| 9 | 1280/320 | 960/640 | 640/960 | 320/1280 | 357.8 |
| 10 | 1440/160 | 1013/587 | 587/1013 | 160/1440 | 477.0 |

TABLE 4
Diabetic retinopathy and Chest X-ray mean and standard deviation
test set accuracies across 10 runs for the various label distribution
splits with centrally hosted and distributed training. Bold
entries represent optimizations that resulted in significantly
better performance than performance of cyclical weight transfer
without optimizations for the same split.

| | DR Test Accuracy | CXR Test Accuracy |
|---|---|---|
| Model | Mean ± Std. Dev. | Mean ± Std. Dev. |
| Split 6 | | |
| Central Hosting | 78.3 ± 0.9 | 76.5 ± 0.9 |
| CWT | 77.9 ± 1.0 | 76.2 ± 0.7 |
| CWT + LWMS | 78.0 ± 1.0 | 75.9 ± 0.9 |
| CWT + CWL | 77.7 ± 1.2 | 76.4 ± 0.7 |
| Split 7 | | |
| Central Hosting | 78.0 ± 0.7 | 76.7 ± 0.7 |
| CWT | 77.0 ± 0.8 | 75.5 ± 0.5 |
| CWT + LWMS | 77.7 ± 0.7 | 76.3 ± 0.9 |
| CWT + CWL | 78.0 ± 0.8 | 76.1 ± 0.7 |
| Split 8 | | |
| Central Hosting | 78.4 ± 0.5 | 77.0 ± 0.6 |
| CWT | 76.3 ± 0.8 | 74.9 ± 0.8 |
| CWT + LWMS | 77.3 ± 0.5 | 75.8 ± 1.0 |
| CWT + CWL | 77.8 ± 0.7 | 76.2 ± 0.8 |
| Split 9 | | |
| Central Hosting | 78.4 ± 0.7 | 76.2 ± 0.8 |
| CWT | 75.9 ± 0.8 | 73.5 ± 0.8 |
| CWT + LWMS | 77.1 ± 0.9 | 75.6 ± 0.6 |
| CWT + CWL | 77.1 ± 0.6 | 75.1 ± 0.4 |
| Split 10 | | |
| Central Hosting | 77.9 ± 0.6 | 76.6 ± 0.4 |
| CWT | 74.4 ± 0.6 | 73.5 ± 0.7 |
| CWT + LWMS | 76.8 ± 0.8 | 75.9 ± 0.7 |
| CWT + CWL | 77.2 ± 0.8 | 75.4 ± 0.6 |

TABLE 5
Institutional training splits with varying degrees sample size standard deviation across the
four institutions, and varying degrees positive/negative label sample size standard deviation.
The number of positive and negative samples at each institution are also indicated.

| | | | | | Sample size | Pos. Sample size | Neg. Sample size |
|---|---|---|---|---|---|---|---|
| Split | Inst1+/− | Inst2+/− | Inst3+/− | Inst4+/− | Std. Dev. | Std. Dev. | Std. Dev. |
| 11 | 800/800 | 800/800 | 800/800 | 800/800 | 0.0 | 0.0 | 0.0 |
| 12 | 1826/200 | 1024/150 | 100/220 | 250/2630 | 1100.71 | 792.27 | 1220.36 |

TABLE 6
Diabetic retinopathy mean and standard deviation test set accuracies across 3 runs for the various
sample size and label distribution splits with centrally hosted and distributed training.

| | Central hosting | CWT | CWT + PLTI | CWT + CWL | CWT + PLTI + CWL |
|---|---|---|---|---|---|
| Split 11 | 78.4 ± 0.5 | 77.99 ± 0.80 | 77.45 ± 0.78 | 77.46 ± 0.78 | 77.50 ± 0.78 |
| Split 12 | 78.4 ± 0.5 | 66.04 ± 4.49 | 72.79 ± 2.27 | 72.625 ± 2.12 | 75.39 ± 0.66 |

What is claimed is:

1. A method for robust federated training of neural networks, comprising:
performing a first number of training iterations with a neural network using a first set of training data; and
performing a second number of training iterations with the neural network using a second set of training data;
wherein the training methodology includes a function to compensate for at least one of sample size variability and label distribution variability between the first set of training data and the second set of training data.

2. The method of claim 1, wherein the first set of training data and the second set of training data set are medical image data.

3. The method of claim 1, wherein the first set of training data set and the second training data set are located at different institutions.

4. The method of claim 1, wherein the neural network is trained in accordance with a training strategy selected from the group consisting of: asynchronous gradient descent, split learning, and cyclical weight transfer.

5. The method of claim 1, wherein the first number of iterations is proportional to the sample size in the first set of training data and the second number of iterations is proportional to the sample size in the second set of training data.

6. The method of claim 1, wherein a learning rate of the neural network is proportional to sample size in the first set of training data and the second set of training data, such that the learning rate is smaller where a set of training data is small and the learning rate is larger when a set of training data is large.

7. The method of claim 1, wherein local training samples are weighted by label during minibatch sampling so that the data from each label is equally likely to get selected.

8. The method of claim 1, wherein the function to compensate is a cyclically weighted loss function giving smaller weight to a loss contribution from labels over-represented in a training set and greater weight to a loss contribution from labels under-represented in a training set.

9. A method for robust federated training of neural networks, comprising
training an image generation network to produce synthetic images using a first set of training data;
training the image generation network to produce synthetic images using a second set of training data; and
training a neural network based on the synthetic images produced by the image generation network.

10. The method of claim 9, wherein the synthetic images do not contain sensitive or private information for a patient or study participant.

11. The method of claim 9, further comprising training a universal classifier model based on the first set of training data, the second set of training data, and the synthetic images.

12. The method of claim 9, wherein the first set of training data set and the second training data set are located at different institutions.

13. The method of claim 9, wherein the first set of training data and the second set of training data set are medical image data.

14. The method of claim 9, wherein the neural network is trained in accordance with a training strategy selected from the group consisting of: asynchronous gradient descent, split learning, and cyclical weight transfer.

15. A method for robust federated training of neural networks, comprising:
creating a first intermediate feature map from a first set of training data, wherein the first intermediate feature map is accomplished by propagating the first set of training data through a first part of a neural network;
creating a second intermediate feature map from a second set of training data, wherein the second intermediate feature map is accomplished by propagating the second set of training data through a first part of a neural network;
transferring the first intermediate feature map and the second intermediate feature map to a central server, wherein the central server concatenates the first intermediate feature map and the second intermediate feature map; and
propagating the concatenated feature maps though a second part of the neural network.

16. The method of claim 15, further comprising generating final weights from the second part of the neural network.

17. The method of claim 16, wherein the first set of training data set and the second training data set are located at different institutions.

18. The method of claim 17, further comprising back propagating the final weights through the layers to each institution.
